(19) United States
(12) Patent Application Publication
(10) Pub. No.: US 2025/0183550 A1
(43) Pub. Date: Jun. 5, 2025

(54) PHASED ARRAY ANTENNA FEED COMBINER

(71) Applicant: The MITRE Corporation, McLean, VA (US)

(72) Inventors: John Patrick LISTON, Wilmington, MA (US); Mohamed Wajih ELSALLAL, Acton, MA (US); Francisco Fernando RAMOS-CARRIZOSA, Roseville, MN (US); Kevin HANSEN, Cambridge, MA (US)

(73) Assignee: The MITRE Corporation, McLean, VA (US)

(21) Appl. No.: 18/968,529

(22) Filed: Dec. 4, 2024

Related U.S. Application Data
(60) Provisional application No. 63/605,911, filed on Dec. 4, 2023.

(51) Int. Cl. H01Q 21/00; H01Q 21/24

(52) U.S. Cl. CPC H01Q 21/0006; H01Q 21/24

(57) ABSTRACT

Described herein are feed networks for phased array antennas. An exemplary feed combiner assembly for a phased array antenna can electrically combine multiple radiating elements in a column for connection to a common feed line of a feed network. This enables transmission of a signal to the multiple radiating elements with a single feed line, reducing the number of feed lines required for feeding the radiating elements. The feed combiner assembly can provide for a more compact feed network and easier replacement than a conventional feed line connection configuration. Each radiating element of the phased array antenna can have a capacitive coupling portion that capacitively couples the radiating element to adjacent radiating elements. The spacing between adjacent radiating elements can be controlled by a non-conductive, overmolded spacer disposed on the capacitive coupling portion, which aligns and maintains a minimum separation between adjacent radiating elements.

### CROSS REFERENCE TO RELATED APPLICATIONS

This application claims the benefit of U.S. Provisional Application No. 63/605,911, filed Dec. 4, 2023, the entire contents of which is incorporated herein by reference.

### FIELD

The present invention relates generally to phased array antennas, and more specifically to feed networks for phased array antennas.

### BACKGROUND

There are increasing demands to develop wideband phased array antennas that include a wide variety of configurations for various applications, such as satellite communications (SATCOM), radar, remote sensing, direction finding, and other systems. The goal is to provide more flexibility and functionality at reduced cost with consideration to limited space, weight, and power consumption (SWaP) on modern military and commercial platforms.

A phased array antenna is an array of antenna elements in which the phases of respective signals feeding the antenna elements are set in such a way that the effective radiation pattern of the array is reinforced in a desired direction and suppressed in undesired directions, thus forming a beam. The relative amplitudes of constructive and destructive interference effects among the signals radiated by the individual elements determine the effective radiation pattern of the phased array. The number of antenna elements in a phased array antenna is often dependent on the required gain of a particular application and can range from isotropic to highly directive levels.

Conventional phased array antennas are often large, causing excessive size, weight, and cost for applications requiring many elements. The excessive size of a phased array antenna may be required to accommodate “electrically large” radiating elements (several wavelengths in length), increasing the total depth of the array. Phased array antennas may also be large due to the accommodation of numerous interconnect configurations (e.g., SMA connectors) for connecting the radiating elements to transmission feed lines (e.g., co-axial cables; also referred to herein as “signal lines”) of a feed network.

Because conventional phased array antennas are often large and include many individual components, the antenna may not be space-efficient or repair-efficient. For example, the interconnect configurations of conventional phased array antennas occupy a large footprint and require many individual components, which are difficult to replace. Thus, more space-efficient and repair-efficient techniques for connecting radiating elements to feed lines are needed.

Furthermore, due to the small size of components in a conventional phased array antenna and the narrow tolerances between the components, it is difficult to electrically isolate the radiating elements from each other. This can lead to a reduction in the bandwidth of the antenna. Existing techniques for separating the radiating elements often involve manufacturing additional components and manually assembling them, which can be expensive and time-consuming. Thus, techniques for separating the radiating elements involving fewer additional components and easier assembly are needed.

### SUMMARY

According to various embodiments, a feed combiner assembly for a phased array antenna having multiple columns of radiating elements is configured to electrically combine multiple radiating elements in a column for connection to a common feed line of a feed network. This enables transmission of a signal to the multiple radiating elements with a single feed line, reducing the number of feed lines required for feeding the radiating elements. The feed combiner assembly can provide for a more compact feed network and easier replacement than a conventional feed line connection configuration.

The feed combiner assembly includes a plurality of combiner cards. Each combiner card may have connectors that connect to feed pins of the radiating elements. The connectors may be connected to electrical traces within the combiner card that merge such that multiple connectors are electrically connected to one another. Electrical traces may merge into a connector for a feed line such that the feed line is electrically connected to multiple connectors. Thereby, when the combiner card is connected to the radiating elements, the feed line is electrically connecting to multiple radiating elements. A combiner card may be configured to connect to one or more columns of radiating elements or one or more portions of columns of radiating elements. A combiner card may be configured to separately combine different columns of radiating elements so that different feed lines can be connected to the different columns.

According to various embodiments, a phased array antenna has multiple radiating elements narrowly spaced apart from each other. Each radiating element may have a capacitive coupling portion that capacitively couples the radiating element to adjacent radiating elements. The spacing between adjacent radiating elements may be controlled by a non-conductive, overmolded spacer disposed on the capacitive coupling portion, which aligns and maintains a minimum separation between adjacent radiating elements. This self-aligning overmolded spacer requires less assembly and uses fewer components than a conventional spacing technique.

According to various embodiments, a feed combiner assembly is used for a phased array antenna that includes columns of radiating element feed pins. The feed combiner assembly includes a plurality of combiner cards, each combiner card including: a connector block that comprises a plurality of connectors configured to connect to at least a portion of the radiating element feed pins of at least two of the columns of radiating element feed pins; a first set of traces for electrically connecting radiating element feed pins of at least a portion of a first column of the at least two of the columns of radiating element feed pins; a second set of traces for electrically connecting radiating element feed pins of at least a portion of a second column of the at least two of columns of radiating element feed pins; a first signal line connector for connecting a first signal line to the combiner card; and a second signal line connector for connecting a second signal line to the combiner card.

In any of these embodiments, the first set of traces can connect a first half of the plurality of connectors, and the second set of traces can connect a second half of the plurality of connectors. One or both of the first set of traces and the second set of traces can be arranged in a branching configuration, such that each set of traces includes a first bifurcation region in which a first parent trace branches into a pair of child traces. Each of the child traces can itself be a parent trace that bifurcates to another pair of child traces. One or both of the first set of traces and the second set of traces can include a printed circuit board.

In any of these embodiments, the plurality of connectors can be arranged in rows, and each row can be configured to connect to a separate column of radiating element feed pins. Signals can be transmitted independently via the first and second signal line connectors to the phased array antenna to which the feed combiner assembly is connected.

In any of these embodiments, each combiner card can further include a cover plate configured to cover one or both of the first set of traces and the second set of traces. Each combiner card can further include a spacer for separating the first set of traces from the second set of traces.

In any of these embodiments, each combiner card can connect to radiating element feed pins of one polarization. In some embodiments, each combiner card can connect to radiating element feed pins of two or more different polarizations. Each combiner card can connect to all of the radiating element feed pins of two of the columns of radiating element feed pins. Two or more combiner cards of the plurality of combiner cards can be disposed next to each other such that each combiner card connects to less than all of the radiating element feed pins of two of the columns of radiating element feed pins.

In any of these embodiments, each combiner card can include a first beamforming integrated circuit configured to receive a first input signal from the first signal line and provide a first set of output signals to the first set of traces; and a second beamforming integrated circuit configured to receive a second input signal from the second signal line and provide a second set of output signals to the second set of traces. The first beamforming integrated circuit can be configured to provide a first output signal having a first amplitude and phase to a first trace of the first set of traces and a second output signal having a second amplitude and phase different from the first amplitude and phase to a second trace of the first set of traces.

According to various embodiments, a phased array antenna includes: a plurality of radiating element feed pins arranged in columns; and a feed combiner assembly that includes a plurality of combiner cards, each combiner card including: a connector block that comprises a plurality of connectors configured to connect to at least a portion of the radiating element feed pins of at least two of the columns of radiating element feed pins; a first set of traces for electrically connecting radiating element feed pins of at least a portion of a first column of the at least two of the columns of radiating element feed pins; a second set of traces for electrically connecting radiating element feed pins of at least a portion of a second column of the at least two of columns of radiating element feed pins; a first signal line connector for connecting a first signal line to the combiner card; and a second signal line connector for connecting a second signal line to the combiner card.

According to various embodiments, a phased array antenna includes: a first radiating element comprising a capacitive coupling portion; and a second radiating element comprising a capacitive coupling portion for capacitively coupling to the capacitive coupling portion of the first radiating element, wherein at least one of the first radiating element and the second radiating element comprises a spacer disposed on the capacitive coupling portion and configured to maintain a minimum separation between the capacitive coupling portion of the first radiating element and the capacitive coupling portion of the second radiating element.

In any of these embodiments, the spacer can be disposed on a top corner of the capacitive coupling portion of the first radiating element. The spacer can extend a full height of the capacitive coupling portion of the first radiating element. In some embodiments, the spacer can extend less than a full height of the capacitive coupling portion of the first radiating element. The capacitive coupling portion of the first radiating element can include a notch for receiving the spacer.

In any of these embodiments, the minimum separation can be less than or equal to 0.01 inches. The spacer can be molded onto the capacitive coupling portion of the first radiating element via overmolding, insert molding, single-shot molding, double-shot molding, co-injection molding, sandwich molding, or any combination thereof.

### BRIEF DESCRIPTION OF THE DRAWINGS

The invention will now be described, by way of example only, with reference to the accompanying drawings, in which:

FIG. 1 illustrates a plan view of an exemplary dual-polarized phased array antenna, according to examples of the disclosure.

FIG. 2A illustrates an orthogonal view of an exemplary radiating element that includes a signal ear and a ground ear projecting from a base plate, according to examples of the disclosure.

FIG. 2B illustrates a side view of a column of signal ears that are connected to a feed network, according to examples of the disclosure.

FIG. 3A illustrates an exemplary combiner card of a feed combiner assembly for connecting signal ears to the feed lines of the feed network, according to examples of the disclosure.

FIG. 3B illustrates an exemplary PCB having a set of signal traces, according to examples of the disclosure.

FIG. 3C illustrates the layers of an exemplary PCB, according to examples of the disclosure.

FIG. 3D illustrates how the various components of an exemplary combiner card may be positioned relative to each other, according to examples of the disclosure.

FIG. 3E illustrates an exemplary combiner card including a beamforming integrated circuit (BFIC) integrated with a PCB, according to examples of the disclosure.

FIG. 4 illustrates an exemplary feed combiner assembly having multiple combiner cards, according to examples of the disclosure.

FIG. 5A illustrates an exemplary array having an overmolded spacer, according to examples of the disclosure.

FIG. 5B illustrates an exemplary overmolded spacer for a signal ear, according to examples of the disclosure.

### DETAILED DESCRIPTION

Described herein, according to various embodiments, are examples of feed combiner assemblies for phased array antennas having multiple columns of radiating elements. A feed combiner assembly can include a plurality of combiner cards, each combiner card electrically connecting multiple radiating elements. Each combiner card includes one or more feed line connectors for connecting feed lines for feeding signals to (and/or receiving signals from) radiating elements that the combiner card connects to. Each combiner card may have radiating element connectors that connect to feed pins on the radiating elements. The combiner card includes electrical traces that electrically connect multiple radiating element connectors to a feed line connector. The electrical traces may be arranged in a branching configuration that electrically connects radiating element connectors configured to connect to feed pins of a column of radiating elements. The electrical traces may terminate at a feed line connector, to which a feed line can be connected such that a signal can be fed to all of the electrically connected radiating elements via the feed line. A combiner card may be configured to connect to multiple columns of radiating elements. The combiner card may have multiple sets of electrical traces, each set connecting to a different feed line connector. Connecting multiple radiating elements (e.g., all the radiating elements in a column) per feed line reduces the number of individual components required for the connection. This can provide for more compact design and easier replacement of the feed combiner assembly.

A phased array antenna, according to various embodiments, can include a repeating pattern of radiating elements arranged in “columns.” Each column can include a plurality of radiating elements that may be driven with a common signal. Each radiating element can include a pair of radiating ears projecting from the base plate. One ear of each pair of ears can be a signal or active component of the radiating element (referred to herein as the “signal ear”) and can be connected to a feed line via the feed combiner assembly. The signal ear includes a post which extends into an opening in the base plate and connects to the feed combiner assembly on the other side of the base plate. The other ear of the pair of ears can be a ground component of the radiating element (referred to herein as the “ground ear”). The ground ear can be electrically connected to the base plate, which is electrically grounded.

According to various embodiments, the signal ear post which extends into an opening in the base plate may be connected to or may terminate in a feed pin. The feed pin can be the end of the post or can include a wired connection component connected to the end of the post (such as a bullet, a barrel, an adapter, a connector, or any combination thereof). A feed combiner assembly, according to the principles described herein, is used to connect feed lines to the feed pins.

According to various embodiments, the feed combiner assembly can include one or more combiner cards, each of which connects to multiple radiating elements in a column. A single combiner card may be configured to connect to multiple columns of radiating elements. A combiner card includes at least one feed line connector to which a feed line can be connected for feeding signals to (and/or receiving signals from) the electrically connected radiating elements. An exemplary combiner card can connect different columns of radiating elements to a different feed line such that the signal transmission for one column is isolated from the signal transmission of another column.

An exemplary combiner card may include a connector block that includes multiple connectors for connecting to multiple feed pins. A connector block may be connected to a set of electrical traces on at least one PCB that merge together to electrically connect the connectors of the connector block together. The electrical traces may merge into a feed line connector, such that a feed line connected to the feed line connector can transmit a signal to the multiple signal ears connected to the connector block. A set of traces may combine any number of connectors of any number of connector blocks. Each set of electrical traces can include a branching configuration, such that a parent trace originating from the feed line branches off into a pair of child traces, and each child trace is itself a parent trace that bifurcates to another pair of child traces. This configuration can propagate until each child trace is connected to a signal ear, and thus, each signal ear is electrically connected to the feed line. The electrical traces may be separated from other conductive components of the PCB by an insulating gap and/or a non-conductive material to ensure that they are electrically isolated, which prevents crosstalk. The other conductive components of the PCB may be grounded (e.g., using grounding vias) to further prevent crosstalk.

According to various embodiments, an exemplary combiner card may be line replaceable (i.e., designed to be easily unplugged and replaced). The combiner card can be easily attached to and detached from the phased array antenna. The combiner card can be connected to multiple radiating elements by pushing the connectors of the combiner card together with the feed pins of the radiating elements. This connection holds the combiner card in place relative to the other components of the phased array antenna. The combiner card can also be easily attached to and detached from one or more feed lines. By pushing each feed line connector of the combiner card together with a feed line, the combiner card can attach to the feed network. A combiner card can be line replaced by disconnecting the feed lines, pulling the connectors away from the feed pins of the radiating elements, and swapping out the card for another card. According to various embodiments, an exemplary combiner card can be modular. Multiple combiner cards can be connected next to each other to form the feed combiner assembly, and one combiner card can be replaced without needing to replace or move the other combiner cards.

According to various embodiments, the signal ears of adjacent radiating elements may be placed close together to ensure capacitive coupling, but this narrow spacing makes it difficult to electrically isolate the signal ears from each other. An overmolded spacer, as described herein, may eliminate this difficulty. For example, the spacing between adjacent signal ears may be preserved by a non-conductive, overmolded spacer on the comb portion of the signal ears, which aligns and maintains a minimum separation between the radiating elements.

In the following description of the disclosure and embodiments, reference is made to the accompanying drawings in which are shown, by way of illustration, specific embodiments that can be practiced. It is to be understood that other embodiments and examples can be practiced and changes can be made without departing from the scope of the disclosure.

In addition, it is also to be understood that the singular forms “a,” “an,” and “the” used in the following description are intended to include the plural forms as well, unless the context clearly indicates otherwise. It is also to be understood that the term “and/or” as used herein refers to and encompasses any and all possible combinations of one or more of the associated listed items. It is further to be understood that the terms “includes, “including,” “comprises,” and/or “comprising,” when used herein, specify the presence of stated features, integers, steps, operations, elements, components, and/or units, but do not preclude the presence or addition of one or more other features, integers, steps, operations, elements, components, units, and/or groups thereof.

Reference is sometimes made herein to an array antenna having a particular configuration (e.g., a planar array). One of ordinary skill in the art would appreciate that the techniques described herein are applicable to various sizes and shapes of array antennas. It should thus be noted that although the description provided herein describes the concepts in the context of a rectangular array antenna, those of ordinary skill in the art would appreciate that the concepts equally apply to other sizes and shapes of array antennas including, but not limited to, arbitrarily shaped planar array antennas as well as cylindrical, conical, spherical and arbitrarily shaped conformal array antennas.

Reference is also made herein to the array antenna including radiating elements of a particular size and shape. For example, certain embodiments of radiating element are described having a shape and a size compatible with operation over a particular frequency range (e.g., 2-30 GHz). Those of ordinary skill in the art would recognize that other shapes of antenna elements may also be used and that the size of one or more radiating elements may be selected for operation over any frequency range in the RF frequency range (e.g., any frequency in the range from below 20 MHz to above 50 GHz).

Reference is sometimes made herein to generation of an antenna beam having a particular shape or beam width. Those of ordinary skill in the art would appreciate that antenna beams having other shapes and widths may also be used and may be provided using known techniques such as by inclusion of amplitude and phase adjustment circuits into appropriate locations in an antenna feed circuit.

Described herein are embodiments of frequency-scaled ultra-wide spectrum phased array antennas. These phased array antennas are formed of repeating cells of frequency-scaled ultra-wide spectrum radiating elements. Phased array antennas according to certain embodiments exhibit very low profile, wide bandwidth, low cross-polarization, and high scan-volume while being low cost, small aperture, modular with built-in RF interconnect, and scalable.

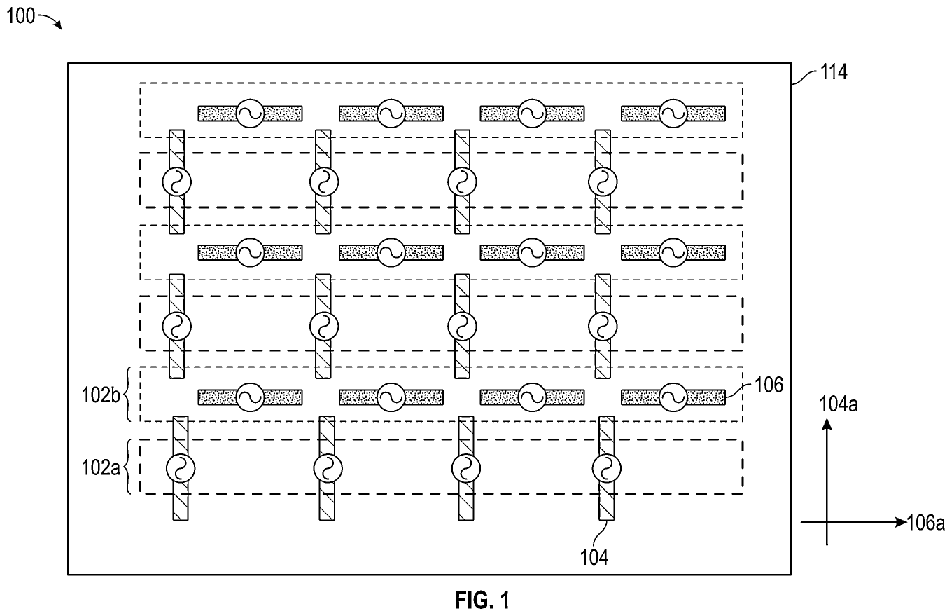

FIG. 1 illustrates an exemplary phased array antenna 100 of radiating elements (e.g., vertical radiating elements 104 and horizontal radiating elements 106) that can form a phased array antenna, according to certain embodiments. In this embodiment, a dual polarized configuration (e.g., which can be driven to provide linear polarization in different directions and/or different circular polarizations) is shown with radiating elements oriented both vertically 104 and horizontally 106 with respect to the view of FIG. 1 (i.e., oriented along first axis 104a and second axis 106a, respectively). A base plate 114 is positioned beneath and supports the radiating elements of the phased array antenna 100.

A column (also referred to herein as a “line” or “row”), such as columns 102a or 102b, includes multiple radiating elements of the same polarization arranged in a line. For example, column 102a includes four vertically oriented radiating elements (e.g., radiating elements 104) of left-hand circular polarization (LHCP), and column 102b includes four horizontally oriented radiating elements (e.g., radiating elements 106) of right-hand circular polarization (RHCP). As used herein, “column” refers to a logical subdivision of a phased array antenna and is not intended to be limited to a distinct component or subassembly. In some embodiments, the columns 102a or 102b may be oriented vertically, horizontally, or diagonally with respect to the view of FIG. 1.

Phased array antenna 100 can include a 6×1 array of columns, such as columns 102a and/or 102b. According to certain embodiments, array 100 can be scaled up or down to operate over a specified frequency range. More columns 102a or 102b can be added to meet other specific design requirements such as antenna gain. According to certain embodiments, modular arrays of a predefined size may be combined into a desired configuration to create an array to meet the required performance of a particular antenna. For example, a module may include the 6×1 array 100 of columns 102a or 102b illustrated in FIG. 1, and a particular antenna application requiring 96 radiating elements can be built using eight modules fitted together (thus, providing the 96 radiating elements). This modular design allows for arrays to be tailored to specific antenna design requirements at a lower cost.

As shown in FIG. 1, radiating elements 104 of column 102a are disposed along a first axis 104a, and radiating elements 106 of column 102b are disposed along a second axis 106a that is orthogonal to the first axis 104a, such that radiating elements 104 are substantially orthogonal to radiating elements 106. This orthogonal orientation results in adjacent columns of radiating elements being able to generate orthogonally directed electromagnetic field polarizations. That is, by disposing one set of radiating elements (e.g., vertical radiating elements 104) in one direction (e.g., first axis 104a) and disposing a second set of radiating elements (e.g., horizontal radiating elements 106) in the orthogonal direction (e.g., axis 104b), the phased array antenna 100 can generate signals having any polarization (e.g., LHCP or RHCP for a circularly polarized antenna). In this particular example, columns 102s and 102b are disposed in a regular pattern, which here corresponds to a repeating linear pattern in which columns of vertical radiating elements 104 alternate with columns of horizontal radiating elements 106, and the positions of the vertical radiating elements 104 are offset both vertically and horizontally from the positions of the horizontal radiating elements 106. Those of ordinary skill in the art would appreciate that columns need not all be disposed in such a pattern. In some applications, it may be desirable or necessary to dispose the columns 102a and 102b in such a way that the positions of the vertical radiating elements 104 are not offset vertically and/or horizontally from the positions of the horizontal radiating elements 106. In some applications, it may be desirable or necessary to dispose the columns 102a and 102b in an irregular pattern. In some applications, it may be desirable or necessary for a phased array antenna 100 to have only vertical radiating elements 104 or only radiating elements 106. In such embodiments, the phased array antenna 100 may be a linearly polarized antenna and may generate signals having vertical polarization or horizontal polarization.

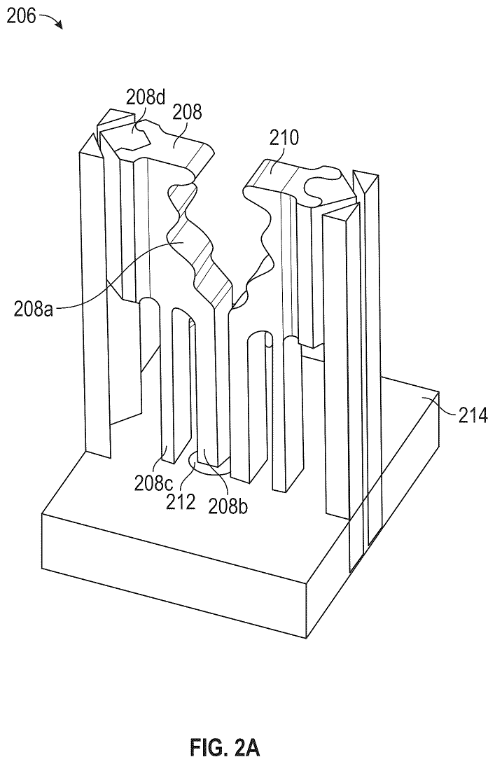

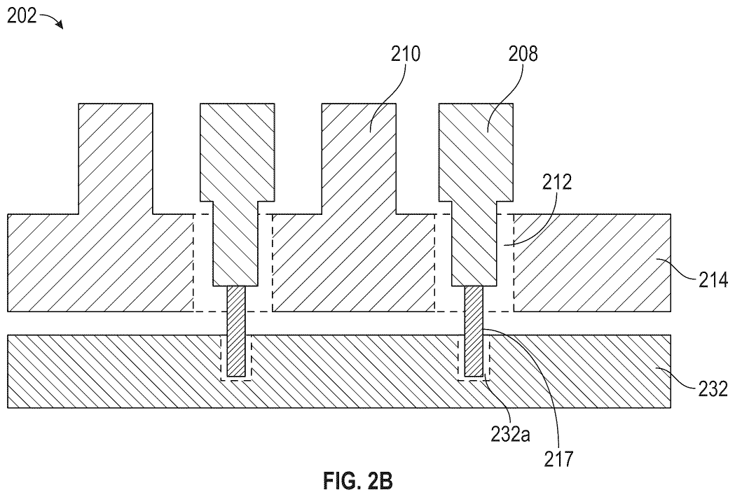

Each of the radiating elements 104 and 106 include a pair of ears projecting from a base plate. Examples of such ears are described in greater detail in the description for FIG. 2A below. Each ear includes a capacitive coupling portion that capacitively couples with adjacent ears to combine the electromagnetic fields of adjacent radiating elements, and at least one post that extends from the capacitive coupling portion toward the base plate. One ear of the pair of ears can be a signal ear, which is a signal or active component of the radiating element that can be connected to a feed line. According to various embodiments, a feed combiner assembly may connect the signal ears of one or more columns of radiating elements to one or more feed lines such that each feed line can transmit a signal to all of the electrically connected signal ears of one column.

FIG. 2A illustrates a perspective view of a apportion of a phased array antenna (such as phased array antenna 100 of FIG. 1) that includes a radiating element 206. Radiating element 206 can be any of radiating elements 114 and 116 of FIG. 1. Radiating element 206 includes a signal ear 208 and a ground ear 210 projecting from a base plate 214.

Signal ear 208 is an antenna element that can be electrically connected to a feed line and/or a feed network that provides the signals for antenna beam forming and steering. As shown, signal ear 208 may project orthogonally from base plate 214 such that its centerline is perpendicular to the base plate 214. Signal ear 208 may be electrically isolated from ground ear 210 and base plate 214. The shape of the signal ear 208 can be configured to optimize the input impedance of the antenna. For example, signal ear 208 may include a comb portion 208a that includes a plurality of irregularly shaped lobes or projections. The comb portion 208a may be located at the end of the signal ear 208 opposite the end connected to the base plate 214. The placement, sizes, shapes, spacing, and numbers of the lobes can affect the impedance transformation of the radiating element 206. The comb portion 208a of the signal ear 208 may project towards the ground ear 210. Adjacent to the comb portion 208a may be a capacitive coupling portion 208d, which may form one or more capacitive interfaces with the capacitive coupling portion of adjacent signal ears. The capacitive coupling portion 208d may be located at the end of the signal ear 208 opposite the end connected to the base plate 214 and may project away from the ground ear 210.

Signal ear 208 may include a signal post 208b that extends at least partially into an opening 212 of base plate 214. The signal post 208b can be electrically connected to a feed network and provides a signal pathway connecting the signal ear 208 to the feed network. For example, the signal post 208b can be connected to a feed combiner assembly on the other side of the base plate 214, as discussed further below. The signal ear 208 may also include a support post 208c that mechanically supports the signal ear 208 and connects the signal ear 208 to base plate 214. In some embodiments, the signal ear 208 may not include support post 208c. The mechanical support for the signal ear 208 may instead be provided by a plug, spacer, or connector which holds the signal post 208b in place while allowing it to connect to the feed combiner assembly. The plug, spacer, or connector may be positioned in the opening 212 of base plate 214. The plug, spacer, or connector may be made of a non-conductive material such that the signal post 208b is electrically isolated from the base plate 214.

Ground ear 210 is an antenna element that is electrically connected to the ground of the antenna. The ground ear 210 can be terminated directly to the base plate 214, which is electrically grounded. As shown in FIG. 2A, the ground ear 210 can mirror the shape of the signal ear 208.

According to certain embodiments, base plate 214 may include a solid block of material with openings, cutouts, or air gaps, such as opening 212, to accommodate the signal post 208b of signal ear 208, as well as a connector (e.g., one or more of an elastomeric connector such as a Fujipoly Zebra® connector, a RF interposer such as a Fuzz Button® connector, and a SMA connector) for connecting the feed combiner assembly to the signal ear 208. It is noted that openings may also be described as air gaps, holes, slots, or cutouts of any shape. According to certain embodiments, the choice of diameter of the opening 212 can also be influenced by the desired impedance of the signal ear 204. In order to achieve suitable impedance matching between the base plate 214 and signal ear 208, the diameter of the corresponding opening 212 can be controlled to ensure that an impedance mismatch does not occur. As the impedance of the signal ear 208 is proportional to the diameter of its signal post 208b, the ratio of the diameter of the signal post 208b to the diameter of the corresponding opening 212 can be controlled so as to achieve suitable impedance matching.

FIG. 2B illustrates a side view of a column 202 of signal ears that are configured to connect to a connector block 232 of a feed combiner assembly for connecting signal ears to a feed network. Column 202 includes two signal ears (e.g., signal ear 208) and two ground ears, (e.g., ground ear 210) in a line. As shown in FIG. 2B, column 202 may be arranged such that signal ears and ground ears are arranged in an alternating fashion (e.g., signal-ground-signal-ground). In some embodiments, column 202 may be arranged such that signal ears are next to other signal ears (e.g., ground-signal-signal-ground), and/or such that ground ears are next to other ground ears (e.g., signal-ground-ground-signal). Each signal ear is connected to its own feed pin (e.g., feed pin 217). In some embodiments, column 202 may include more than or less than two signal ears. For example, column 202 may include, but is not limited to, at least one signal ear, at least two signal ears, at least four signal ears, at least eight signal ears, at least sixteen signal ears, at least thirty-two signal ears, at least sixty-four signal ears, etc.

As shown in FIG. 2B, a signal ear 208 may be disposed at least partially within an opening 212 of the base plate 214. Opening 212 may be configured such that the signal ear 208 does not make contact with the base plate 214. The signal ear 208 may be connected to a feed pin 217, which can connect the signal post 208 to a feed combiner assembly. The feed pin 217 may be disposed within the opening 212 of the base plate 214, positioned on the other side of the base plate 214 relative to the signal post 208b, or both.

According to various embodiments, the feed pin 217 may be a wired connection component, such as a bullet, a barrel, an adapter, a connector, or any combination thereof, that is compatible with the connectors of the feed combiner assembly. For example, the feed pin 217 may be a SMPM connector, a SMA connector, a SMPS connector, a SMP connector, an adapter, or any combination thereof. In some embodiments, the feed pin 217 may be integrated into the construction of the signal ear 208 such that it is built into (e.g., a part of) the signal ear 208. In some embodiments, the feed pin 217 may be a separate component that is attachable to and detachable from the signal ear 208. According to certain embodiments, after positioning the signal ear 208 and feed pin 217 in the opening 212, the opening 212 can be filled with a material other than air, such as a resin or other non-conductive material injected into the opening 212, which can provide additional stability and structural support to the signal ear 208 and the feed pin 217. This material may make up the plug, spacer, or connector described previously.

The feed pin 217 may be configured to connect the signal ear 208 to a connector block 232. A connector 232a within the connector block 232 may receive the feed pin 217, thereby forming a connection between the signal ear 208 and the connector block 232. The connector 332a can include a SMPM connector, a SMA connector, a SMPS connector, a SMP connector, an adapter, or any other connector type of any combination thereof. The connector block 232 may hold a plurality of connectors (e.g., connector 232a), in a fixed configuration compatible with the configuration of the feed pins (e.g., feed pin 217) of the signal ears (e.g., signal ear 208).

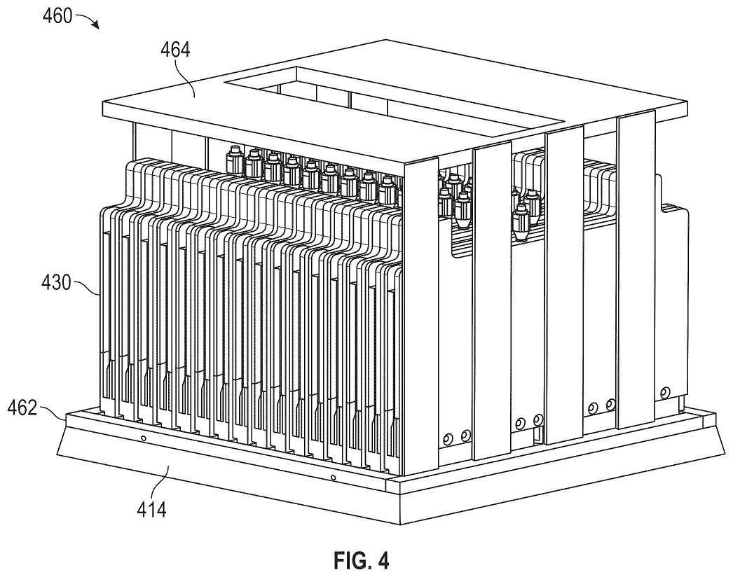

The connector block 232 may be a component of a feed combiner assembly (e.g., feed combiner assembly 460 of FIG. 4), which in turn can connect to the feed lines of the feed network. The feed combiner assembly serves as an intermediary component that streamlines the signal transmission process between the signal ears and the feed lines. In some embodiments, a feed combiner assembly can include a plurality of combiner cards. Each combiner card connects one or more columns of signal ears to the feed network. In some embodiments, each column is connected to a feed line.

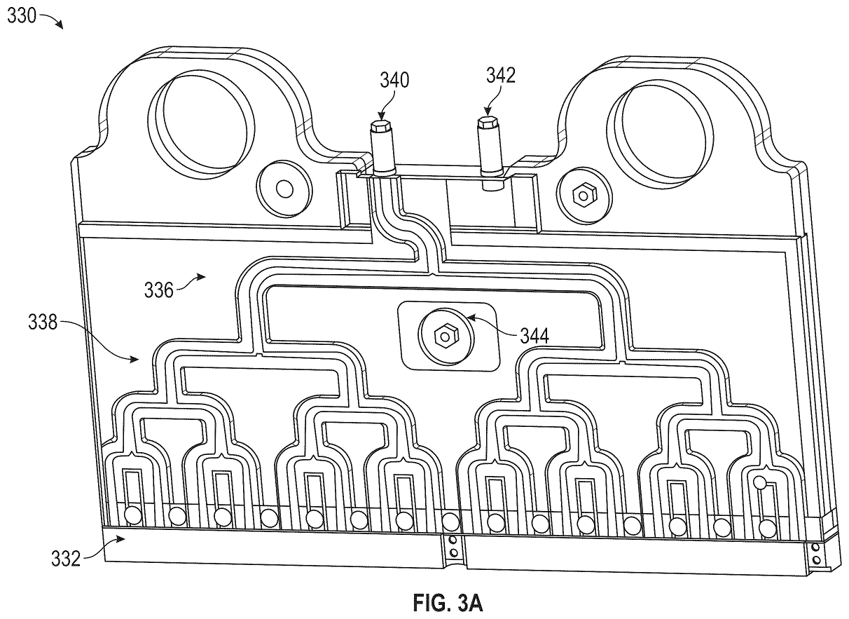

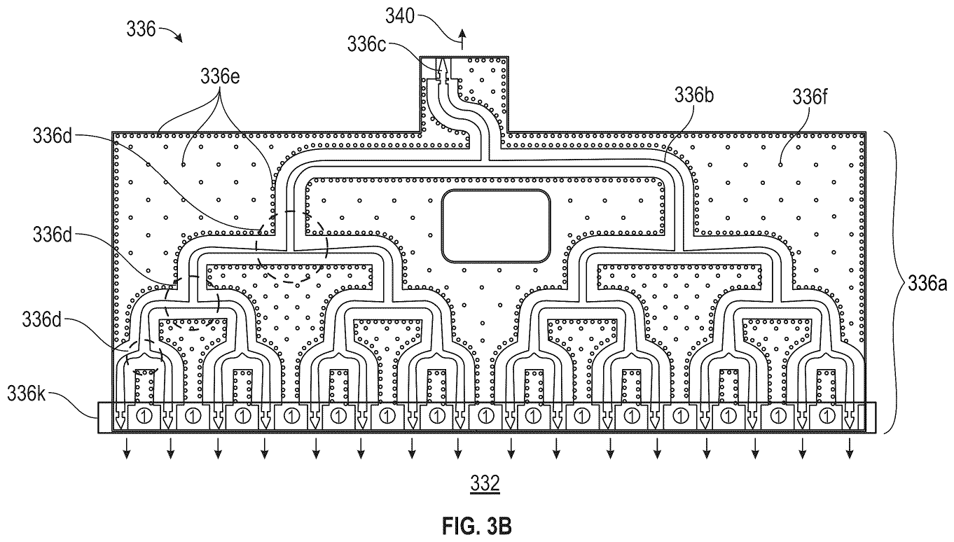

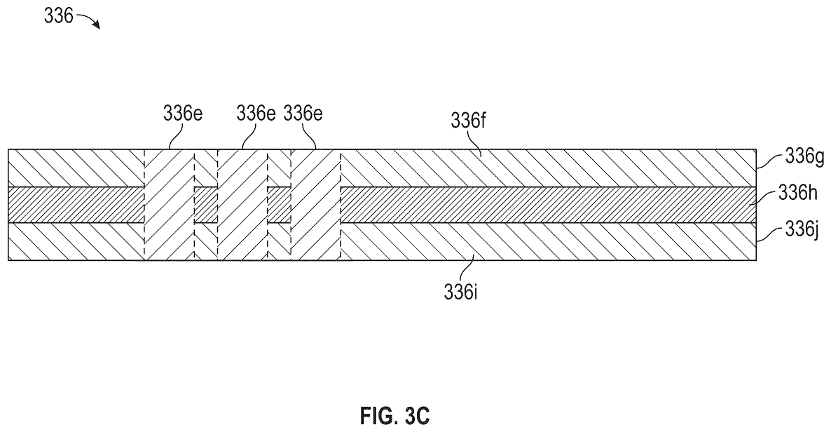

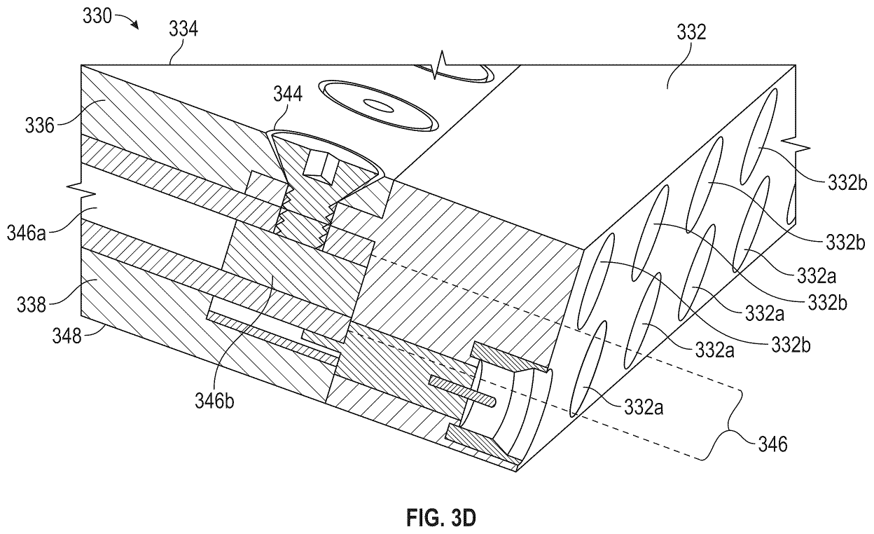

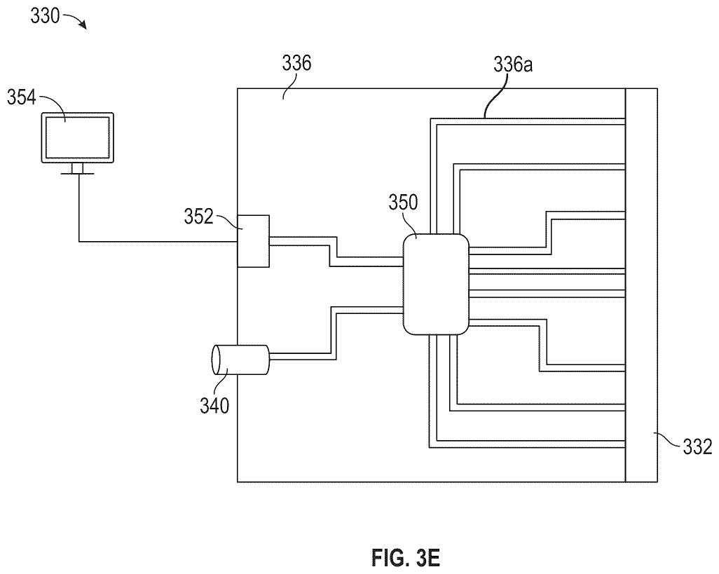

FIG. 3A illustrates an exemplary combiner card 330 of a feed combiner assembly for connecting signal ears to the feed lines of the feed network. The combiner card 330 distributes signals from one or more feed lines to one or more columns or portions of one or more columns of signal ears. The combiner card 330 may be configured to connect to at least a portion of one or more columns of radiating elements via one or more connector blocks 332. In some embodiments, the combiner card 330 may be configured to separately combine one or more columns of radiating elements so that a different feed line can be connected to each column via a feed line connector, such as feed line connectors 340 and 342. For example, the combiner card 330 can include a connector block 332, a first PCB 336, and a second PCB 338. The connector block 332 can transmit signals between the signal ears of the array and the PCBs 336 and 338. The PCBs 336 and 338 can transmit signals between the connector block 332 and the feed line connectors 340 and 342. In some embodiments, the combiner card 330 may connect to some but not all of the radiating elements in a column. In some embodiments, multiple combiner cards 330 may be used to connect to all of the radiating elements in a column.

The combiner card 330 can be easily removed and replaced as a unit. For example, if the feed system for a column of 16 signal ears is malfunctioning, the entire system can be replaced as one unit (i.e., the combiner card 330) instead of manually disconnecting and reconnecting 16 feed lines, one for each signal ear. Thus, the combiner card 330 is a compact and replaceable device for providing antenna beam steering capabilities across different arrays. The combiner card 330 may be independently swappable with other combiner cards without needing to rebuild the entire feed combiner assembly.

The combiner card 330 may have any suitably compact form factor. In the exemplary embodiment of FIG. 3A, the combiner card 330 is approximately 2.5″ tall×5″ wide×1″ deep in size. The size of the combiner card 330 can range between 0.5″ to 50″ on any of the dimensions. The size of the combiner card 330 can depend on the size of the array and the number of radiating elements on the array. The combiner card 330 may feed an array configured to operate at a given frequency, such as the radio frequency band from 1.8 to 18 GHz. The voltage standing wave ratio (VSWR), which is the ratio between transmitted and reflected voltage standing waves in a radio frequency transmission system, of the signal transmission may be less than 2:1. The insertion loss, which is the loss of signal power resulting from the insertion of a device in the transmission line, of the combiner card 330 in the array may be less than 2 dB.

The connector block 332 can transmit signals between the PCBs 336 and 338 and the signal ears of the array. In some embodiments, the connector block 332 may be a solid piece including a plurality of connectors that are configured to connect to a plurality of feed network connectors (e.g., feed pins 217 of FIG. 2B) extending from the signal ears. The feed pins may connect to the plurality of connectors on a first side of the connector block 332, and the PCBs 336 and 338 may connect to a second side of the connector block 332. The connector block 332 may hold the plurality of connectors in a fixed configuration compatible with the configuration of the feed pins of the signal ears. For example, a connector block 332 may have 32 total connectors arranged in two rows of 16 connectors (16 for connecting a first column of signal ears, and 16 for connecting a second column of signal ears). The connector block 332 may connect to a first PCB 336 at a first set of 16 points corresponding to the 16 signal ears of the first column, and to a second PCB 338 at a second set of 16 points corresponding to the 16 signal ears of the second column. The connector block 332 may include more than or less than 32 connectors. For example, the connector block 332 may include, but is not limited to, two connectors, four connectors, eight connectors, sixteen connectors, or sixty-four connectors. The connector block 332 can share any features of connector block 232 of FIG. 2B, and vice versa.

The connector block 332 of the combiner card 330 may be compatible with arrays having the same connector type (e.g., SMPM). For example, the connectors of the connector block 332 can include a SMPM connector, a SMA connector, a SMPS connector, a SMP connector, an adapter, or any combination thereof. In some embodiments, the connection standard on a first side of the connector block 332 (e.g., the side connected to the feed pins) may differ from the connection standard on a second side of the connector block 332 (e.g., the side connected to the PCBs 336 and 338) such that the orientation of the connector block 332 is determined by the orientations of the connecting components. In some embodiments, the connector block 332 may be eliminated, and the feed pins may directly connect the signal ears to the PCBs 336 and 338. However, eliminating the connector block means that the plurality of connectors are no longer held in a fixed configuration relative to each other and, as a result, may be unstable and difficult to align with the feed pins. As such, removing the connector block 332 may affect the ease with which the combiner card 330 can be attached to and removed from the array.

In some embodiments, the combiner card 330 may include one or more signal conditioning components, such as one or more resistors, capacitors, inductors, etc.

FIG. 3B illustrates an exemplary PCB 336 having a set of signal traces 336a. The PCB 336 may include a conductive layer 336f disposed on a surface of a dielectric layer (e.g., dielectric layer 336h of FIG. 3C). In some embodiments, the conductive layer 336f may include a conductive material (e.g., copper, aluminum, gold, silver, etc.). In some embodiments, the dielectric layer may include an insulating material (e.g., fiberglass, ceramic, epoxy-based composites, etc.). The signal traces 336a are thin, conductive features etched into the conductive layer 336f that carry electrical signals between components (e.g., between the feed line connector 340 and the connector block 332). The traces 336a may be etched out of the conductive layer 336f such that the dielectric layer is exposed on the surface of the PCB 336 and surrounds the traces 336a. In some embodiments, the traces 336a may be separated from other conductive elements of the conductive layer 336f by an insulating gap 336b such that the traces are electrically isolated from the rest of the conductive layer 336f. The insulating gap 336b may follow the shape of the traces 336a along the surface of PCB 336 as they extend between the feed connecting portion 336c, which is used for interfacing with the feed line connector 340, and the block connecting portion 336k, which are used for interfacing with the connector block 332. The regions of the conductive layer 336f not included in the traces 336a may be grounded (e.g., using grounding vias 336e) to help prevent crosstalk between traces.

In some embodiments, the traces 336a branch out from a feed connecting portion 336c to which a feed line connector 340 can be connected. The feed connecting portion 336c may be an end piece of the traces 336a that is located on one side of the PCB 336. The feed connecting portion 336c may be attached to and removed from the feed line connector 340 (e.g., the feed connection portion 336c may plug into the feed line connector 340). As they branch out from the feed connecting portion 336c, the traces 336a may split up into two directions at multiple bifurcation regions 336d located on the conductive layer 336f of the PCB 336. Traces 336a that split up into two directions at the bifurcation regions 336d remain electrically connected to one another. The bifurcation regions 336d allow the traces 336a to branch out from the single signal trace at the feed line connector 340 into multiple signal traces at the block connecting portion 336k. Each of these multiple signal traces 336a may connect to the connector block 332 at a second end of the PCB 336 via the block connecting portion 336k. The block connecting portion 336k may be attached to and removed from the connector block 332 (e.g., the block connecting portion 336k may plug into the connector block 332). The number of signal traces 336a that end at the block connecting portion 336k may be equal to or greater than the number of signal ears in a column of the array.

FIG. 3C illustrates the layers of an exemplary PCB 336. In some embodiments, PCB 336 may include a first conductive layer 336f disposed on a first side 336g of a dielectric layer 336h of PCB 336 and second conductive layer 336i disposed on the second side 336j of the dielectric layer 336h. The traces 336a of FIG. 3B may be disposed on the first conductive layer 336f. The second conductive layer 336i may be grounded. In some embodiments, PCB 336 may include a plurality of grounding vias 336e disposed within the PCB 336, extending from the first conductive layer 336f of the PCB 336 through the dielectric layer 336h to the second conductive layer 336i.

Referring back to FIG. 3B, the grounding vias 336e ground the sections of the conductive layer 336f outside of the signal traces 336a, which mitigates interference with signal transmission. In some embodiments, the grounding vias 336e may be positioned along the exposed dielectric material of the insulating gap 336b that insulates the traces 336a from the other sections of the first conductive layer 336f. In some embodiments, the grounding vias 336e may be positioned along the outer edges of the PCB 336. In some embodiments, the grounding vias 336e may be distributed either uniformly or unevenly throughout the PCB 336 such that sections of the conductive layer 336f are grounded (i.e., connected to the grounded second conductive layer 336i of FIG. 3C).

The set of traces 336a can include a branching configuration, such that a parent trace originating from the feed line branches off into a pair of child traces, and each child trace is itself a parent trace that bifurcates to another pair of child traces. This configuration can propagate until each child trace is connected to a signal ear (via the connector block 332), and thus, each signal ear is electrically connected to the feed line (via the feed line connector 340). As shown in the exemplary PCB 336 of FIG. 3B, the traces 336a may share 16 connection points with the connector block 332, indicating that the PCB 336 is compatible with an array configured to have 16 signal ears per column. Through the branching traces 336a, the signal from the feed line can be sent to the column of 16 signal ears.

Within the combiner card 330, the PCB 336 may transmit a signal from one feed line to a column of signal ears of one polarization. Multiple PCBs may be used to transmit different signals (e.g., signals of different polarizations). For example, the PCB 336 may transmit a LHCP signal from a first feed line (via the feed line connector 340) to a column of vertically oriented signal ears (via the connector block 332). Likewise, PCB 338 of FIG. 3A, which can share any of the features of PCB 336 described herein, may transmit a RHCP signal from a second feed line (via the feed connector 342 of FIG. 3A) to a column of horizontally oriented signal ears (via the connector block 332). Combiner card 330 may comprise both PCBs 336 and 338 in order to simultaneously transmit signals of LHCP and RHCP polarization. In some embodiments, the conductive layers of PCB 336 and 338 may be separated from one another (e.g., by covers or spacers) to prevent the signals from interfering with one another. In some embodiments (e.g., if the signal ears are all vertically oriented or all horizontally oriented), the signals transmitted by the PCB 336 may be vertically polarized or horizontally polarized.

Referring back to FIG. 3A, the first feed line connector 340 connects the first PCB 336 to a feed line of the feed network. The second feed line connector 342 connects the second PCB 338 to another feed line of the feed network. The feed line connectors may be referred to herein as “signal line connectors.” The feed line connectors 340 or 342 can include a SMPM connector, a SMA connector, a SMPS connector, a SMP connector, an adapter, or any combination thereof. The feed line may be a cable, such as a co-axial cable, which connects to the feed line connectors 340 or 342 and transmits signals from the feed network. For example, the first feed line connector 340 may connect to a feed line transmitting LHCP signals, and the second feed line connector 342 may connect to a feed line transmitting RHCP signals from the feed network. In some embodiments, the feed network connects to a signal generator that controls the feed current transmitted to each of the signal ears. The feed network can also be connected to a receiver that receives signals transmitted to the phased array antenna.

FIG. 3D illustrates how the various components of the combiner card 330 may be positioned relative to each other, according to various embodiments. The connector block 332 may be positioned at one end of the combiner card 330. A surface of the connector block 332 may be configured to abut the base plate of the phased array antenna when the combiner card 330 is connected to the phased array antenna. The combiner card 330 may include a central spacer 346 that separates a first PCB 336 on one side and a second PCB 338 on another side. The first PCB 336 may be covered by cover 334, and the second PCB 338 may be covered by a cover 348, such that the signal traces of the PCBs 336 and 338 are protected by the covers 334 and 348, respectively. The structure of the combiner card 330 (i.e., the layered arrangement of the cover 334, the first PCB 336, the spacer 346, the second PCB 338, and the cover 348) enables the combiner card 330 to connect different columns of signal ears to different feed lines. The Separating the first PCB 336 and the second PCB 338 by using the spacer 346 and covering the PCBs with the cover 334 and the cover 348, respectively, allow the two PCBs to carry signals separately, with minimal crosstalk.

In some embodiments, the connector block 332 may include a first set of connectors 332a and a second set of connectors 332b. The first set of connectors 332a may be configured to interface with a first column of signal ears (e.g., the column 102a pictured in FIG. 1), and the second set of connectors 332b may be configured to interface with a second column of signal ears (e.g., the column 102b pictured in FIG. 1). The connectors 332a and 332b can include a SMPM connector, a SMA connector, a SMPS connector, a SMP connector, an adapter, or any other connector type of any combination thereof.

The cover 334 provides both electrical isolation and environmental protection to the first PCB 336. The cover 334 encloses the conductive surface of the first PCB 336 and shields its electrical traces from external electrical interference, ensuring signal integrity and minimizing the risk of signal crosstalk or short-circuits. For example, the cover 334 may have one or both of an insulative layer that adjoins the surface of the first PCB 336 and a conductive layer that provides electrical isolation to the PCB 336. In some embodiments, a surface of the cover 334 (e.g., the insulative layer) directly adjoins a surface of the first PCB 336 such that the gap between the two components is minimal. By acting as a physical barrier, the cover 334 protects the first PCB 336 from dust, moisture, and other harmful environmental factors. Cover 348 may have all of the properties of cover 334 for its respective PCB, the second PCB 338.

The spacer 346, which includes foam portion 346a and metal portion 346b, separates the first PCB 336 from the second PCB 338 and ensures a consistent spacing between them. The foam portion 346a may be made of Rochel foam or a similar high-density foam. The metal portion 346b may be made of aluminum or a similar conductive metal. The combination of foam and metal for the spacer 346 provides a lightweight spacing material (i.e., the foam portion 346a) as well as a sturdy, conductive material (i.e., the metal portion 346b) which is capable of receiving and grounding a screw 344 that extends through the spacer 346. This allows the spacer to be held together with the rest of the components of the combiner card 330.

One or more screws 344 may hold the components of the combiner card 330 together. In some embodiments, a screw 344 may be a 0-80 screw or any appropriate screws. The screw 344 may be made of a conductive material so that it may ensure ohmic contact between the covers 334 and 348 and the ground surfaces of the PCBs 336 and 338. For example, the screw 344 extends through the cover 334, extends through a portion of the connector block 332, extends through and makes contact with the ground surface of the first PCB 336, extends through the aluminum portion 346b of the spacer 346, extends through and makes contact with the ground surface of the second PCB 338, and terminates in or extends through the cover 348. This holds the covers 334 and 348, PCBs 336 and 338, connector block 332, and spacer 346 together while grounding these non-signal-transmitting portions of the combiner card 330.

In some examples, a combiner card may be configured to perform beamforming and provide different beamforming signals to at least some of the signal traces of the PCB. For example, a combiner card may include at least one beamforming integrated circuit (BFIC) integrated with each PCB. A BFIC may be used to control the amplitude and/or phase of the signals provided to the signal traces of the PCB. FIG. 3E illustrates an exemplary combiner card 330 including a BFIC 350 integrated with a PCB 336. Only one PCB with an integrated BFIC is illustrated in FIG. 3E, but it should be understood that a combiner card 330 may include two PCBs with integrated BFICs, similar to FIG. 3A discussed above.

BFIC 350 may receive an input signal from a feed network via a feed line connector 340. BFIC 350 may generate a plurality of output signals based on the input signal and may provide the output signals to signal traces 336a of PCB 336. In the example shown in FIG. 3E, BFIC 350 is configured to provide output signals to eight signal traces. In other examples, BFIC 350 may provide output signals to two, four, six, ten, twelve, fourteen, sixteen, or more signal traces. In some embodiments, BFIC 350 may include one or more circuit elements (e.g., power conditioning components, external connectors, etc.) used for generating the output signals. These elements are not shown for simplicity, but it should be understood that BFIC 350 may include any number of such elements.

The output signals provided to the signal traces by BFIC 350 may be different from one another. For example, the phase and amplitude of a first output signal provided to a first signal trace may be different than the phase and amplitude of a second output signal provided to a second signal trace. The signal traces may provide the output signals to a connector block 332, which can transmit the output signals to radiating elements of an array. Accordingly, the resulting beam produced by the radiating elements to which the signal traces are connected may be steered at the individual radiating element-level, rather than at the combiner card-level.

BFIC 350 may be controlled by a processing unit 354 communicatively connected to an interface 352 of combiner card 330. Interface 352 may be, for example, a serial port interface. Processing unit 354 may include one or more processors, including any of, or any combination of, a central processing unit (CPU), field programmable gate array (FPGA), and application-specific integrated circuit (ASIC). In general, control signals provided by the processing unit 354 to the BFIC 350 control how the BFIC 350 operates on the input signal from the feed line connector 340 to produce the output signals on each signal trace 336a. Processing unit 354 may also control the signal provided to the feed line connector 340 from a feed network. In a feed combiner assembly having multiple combiner cards, the feed network may provide beamforming from combiner card to combiner card, with BFIC 350 providing beamforming for an individual combiner card connected to a feed line via feed line connector 340.

FIG. 4 illustrates a feed combiner assembly 460 having multiple combiner cards 430. In some embodiments, the combiner cards 430 may be arranged in a compact stack such that the bottoms (i.e., the connector blocks) of the combiner cards 430 are all facing in the same direction (i.e., toward the base plate 414). The bottoms of the combiner cards 430 may be surrounded and/or supported by a frame 462 and a tile cover 464. The frame 462 may hold the combiner cards 430 in place for mounting purposes. The tile cover 464 may hold the combiner cards 430 in the desired alignment and may provide additional surfaces for supporting and/or organizing the feed lines connected to the combiner cards 430. The feed combiner assembly 460 may be mounted to the array via the fit between the connectors and the signal ears (e.g., via the feed pins of the signal ears interfacing with the connectors of the connector blocks) through the base plate 414.

The feed combiner assembly 460 configuration illustrated in FIG. 4 may have 16 combiner cards 430. Each combiner card 430 may feed a column of 16 LHCP and a column of 16 RHCP radiating elements. Because a “unit cell” can include one LHCP and one RHCP radiating element, each combiner card 430 can feed 16 unit cells. Thus, with 16 combiner cards 430, the feed combiner assembly 460 can feed a 16×16 subarray of radiating elements. The subarray may be used as a building block for a larger sized array, such as a 32×32 array or a 16×48 array. Multiple feed combiner assemblies 460 may be used together to feed such arrays. In other words, the feed combiner assembly 460 can be tileable and compatible with other feed combiner assemblies, enabling it to feed arrays of various sizes and configurations. The feed combiner assembly 460 is not limited to a 16×16 configuration and may have other configurations, such as 4×4, 8×8, 32×32, 64×64, or any combination thereof.

In some embodiments, multiple combiner cards 430 can be driven simultaneously by the same signal from the feed network. Driving the combiner cards 430 simultaneously can produce one beam of a high gain. In some embodiments, the combiner cards 430 can be driven separately. The combiner cards 430 can be driven such that the array generates two separate beams of lower gain.

### Overmolded Signal Ear Spacer

According to various embodiments, the ears of adjacent radiating elements may be placed close together to ensure capacitive coupling. For example, referring back to FIG. 2A, the capacitive coupling portion 208d of signal ear 208 may be positioned near the capacitive coupling portions of one or more other signal ears or ground ears such that they are capacitively coupled with each other, with only a narrow air gap (e.g., less than 0.01″) between the comb portions. However, this narrow spacing makes it difficult to electrically isolate the ears from each other, which can lead to short-circuiting and reduce the bandwidth of the phased array antenna. Compared to existing techniques for isolating the ears, which often involve manufacturing additional components and manually assembling them, separating the ears with an overmolded spacer involves fewer additional components and easier assembly. For example, manually 3D-printing a cap spacer may be difficult due to the tight spacing (e.g., less than 0.01″, 0.001″, or 0.0001″ between the ears), which is smaller than the tolerancing of many 3D printers, and manually assembling the cap spacers may be difficult due to the manual assembly required to install the caps. An overmolded spacer, as described herein, may eliminate this difficulty. For example, the spacing between adjacent ears may be preserved by a non-conductive, overmolded spacer on the comb portion of at least one of the ears, which aligns and maintains a minimum separation between the radiating elements. Thus, overmolding, which involves molding a substrate material (e.g., the material of the ear) with another material (e.g., the material used for the overmolded spacer) to create a single, integrated part, may be easier to produce and assemble.

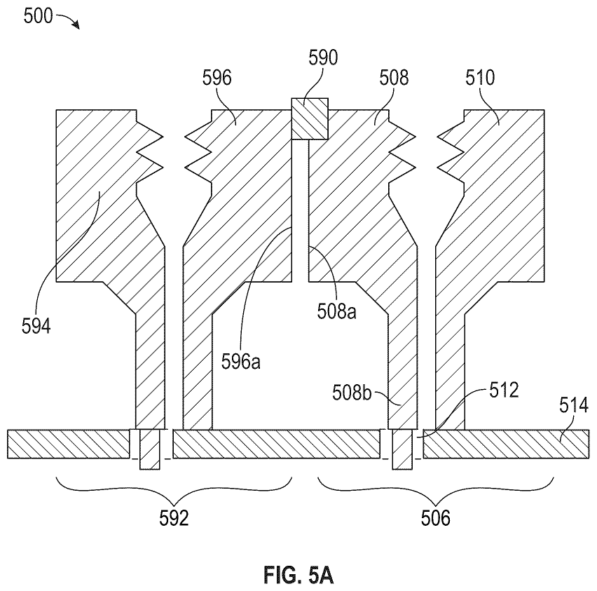

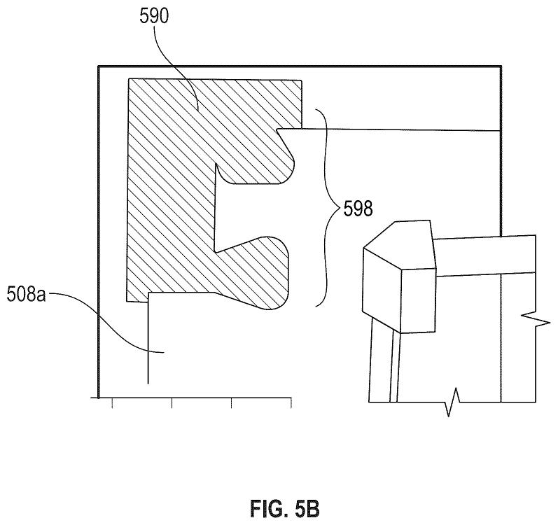

FIG. 5A illustrates a section of an exemplary array 500 having an overmolded spacer 590. The array 500 includes two horizontally polarized radiating elements, 506 and 592. Each of the radiating elements 506 and 592 have a signal ear (508 and 594, respectively) and a ground ear (510 and 596, respectively) projecting from a base plate 514. Radiating element 506 is positioned near radiating element 592 such that all of the ears are in a line, with the signal ears 508 and 594 alternating with their respective ground ears 510 and 596). The signal ear 508 of radiating element 506 and the ground ear 596 of radiating element 594 are positioned proximate to each other such that their comb portions 508a and 596a are almost but not quite touching. An overmolded spacer 590 attached to signal ear 508 maintains this spacing between signal ear 508 and signal ear 594.

The signal ear 508 may share any of the features of signal ear 208 from FIG. 2A. As shown in FIG. 5A, As shown, signal ear 508 may project orthogonally from base plate 514 such that its centerline is perpendicular to the largest surface of base plate 514. Signal ear 508 may be electrically isolated from ground ear 510 and base plate 514. Signal ear 508 may include a capacitive coupling portion 508a at an end of the signal ear 508 (i.e., the end farther away from base plate 514). The comb portion 508a may form a capacitive interface with a capacitive coupling portion 596a of an adjacent ground ear 596. Signal ear 508 may include a signal post 508b that extends at least partially into an opening 512 of base plate 514. The signal post 508b can be electrically connected to a feed network and provides a signal pathway connecting the signal ear 508 to the feed network. For example, the signal post 508b can be connected to a feed combiner assembly (e.g., feed combiner assembly 460 of FIG. 4) on the other side of the base plate 514. Unlike signal ear 208 of FIG. 2A, the signal ear 508 of FIG. 5A does not include a support post that connects the signal ear 508 to the surface of the base plate 514. Instead, the mechanical support for the signal ear 508 may be provided by a plug, spacer, or connector positioned in the opening 512 of base plate 514. The plug, spacer, or connector may be made of a non-conductive material such that the signal post 508b is electrically isolated from the base plate 514. Signal ear 594 may share any of the features of signal ear 508 of FIG. 5A and/or signal ear 208 of FIG. 2A.

As shown, signal ear 508 includes an overmolded spacer 590. The overmolded spacer 590 is disposed on a top corner of the capacitive coupling portion 508a such that it separates the comb portion 508a from the capacitive coupling 596a of the adjacent ground ear 596. This placement of the spacer 590 allows the signal ear 508 to self-align itself relative to adjacent ears, maintaining an air gap between the ears. In some embodiments, the thickness of the overmolded spacer 590 may be selected to ensure a minimum separation between the signal ear 508 and the ground ear 596 of less than or equal to 0.01″, 0.001″, or 0.0001″. The length of the overmolded spacer 590 may be kept small (e.g., less than or equal to 0.1″), so as to minimize surface area making contact between the signal ear 508 and the ground ear 596. This is because there may be negative performance impacts associated with making physical contact between the signal ear 508 and ground ear 596, and the performance impacts may be larger for larger areas of contact. In some embodiments, the overmolded spacer 590 may be positioned in a location other than the top corner of the capacitive coupling portion 508a. For example, the overmolded spacer 590 may be positioned anywhere along the edge of the signal ear 508, such as anywhere along the outer edge of the capacitive coupling portion 508a, or, even lower down, along the signal post 508b, as long as the separation between the signal ear 508 and the ground ear 596 can be maintained. In some embodiments, both signal ear 508 and ground ear 596 can include an overmolded spacer 590 disposed on their respective capacitive coupling portions 508a and 596a. In some embodiments, only one of the ears includes an overmolded spacer 590.

In some embodiments, the overmolded spacer 590 may include a rigid, non-conductive material. The non-conductive material may be, for example, a liquid crystal polymer. To overmold the spacer 590 onto the signal ear 508, a notch for receiving the spacer 590 may be machined, manufactured, or created on the comb portion of the signal ear 508. FIG. 5B illustrates a close-up view of signal ear 508 which includes a notch 598 on the comb portion 508a for receiving the overmolded spacer 590. To form the overmolded spacer 590, an overmolding manufacturing process may be used. Overmolding involves molding a substrate material (e.g., the material of the signal ear 508) with another material (e.g., the non-conductive material used for the overmolded spacer 590) to create a single, integrated part. For example, the overmolding process may involve clamping a mold onto the signal ear 508 near the notch 598. The non-conductive material may be melted and injected into the mold, bonding with the material of the substrate (e.g., the signal ear 508). The materials may be cooled and cured in the mold to solidify the overmolded spacer 590 and ensure its adhesion to the signal ear 508. After the overmolded spacer 590 has solidified, the mold may be removed. In some embodiments, other manufacturing processes may also be used to form the spacer 590. The manufacturing processes may include, for example, insert molding, single-shot molding, double-shot molding, co-injection molding, sandwich molding, or any combination thereof.

In accordance with the foregoing, according to certain embodiments, a LHCP radiating element of a dual polarized phased array antenna is of the same size, shape, and spacing as a RHCP radiating element. A horizontally polarized radiating element of a linearly polarized phased array antenna is of the same size, shape, and spacing as a vertically polarized radiating element. However, phased array antennas according to other embodiments, may include only single polarized radiating elements (e.g., only rows of RHCP radiating elements, or only rows of horizontally polarized radiating elements). According to some embodiments, the spacing of one set of radiating elements (e.g., the horizontally polarized elements) is different from the spacing of the other set of radiating elements (e.g., the vertically polarized elements). According to some embodiments, the radiating element spacing within a row may not be uniform. For example, the spacing between first and second elements within a row may be different than the spacing between the second and third elements.

According to some embodiments, the signal ears and the ground ears described herein are solid antenna elements. According to certain embodiments, the thickness of these elements is less than 0.5 inches or less than 0.25 inches. According to certain embodiments, the thickness is preferably less than 0.125 inches, less than 0.063, less than 0.032, less than 0.016, or less than 0.008 inches. According to certain embodiments, the thickness is between 0.035 and 0.045 inches. According to certain embodiments, the thickness is greater than 0.03 inches, greater than 0.1 inches, greater than 0.25 inches, greater than 0.5 inches, or greater than 1 inch. According to some embodiments, the thickness may be scaled with frequency (for example, the distance may be a function of the wavelength of the highest designed frequency). For example, according to some embodiments, the thickness can be less than 0.22, less than 0.12, less than 0.052, or less than 0.012. According to some embodiments, the thickness can be greater than 0.0052, greater than 0.012, greater than 0.052, or greater than 0.12.

According to certain embodiments, the signal ears, ground ears, and base plates described herein are formed from any one or more materials suitable for use in a radiating antenna. In a preferred embodiment, one or more of these materials is a non-conductive material, for example plastics such as Acrylonitrile butadiene styrene (ABS), Nylon, Polyamides (PA), Polybutylene terephthalate (PBT), Polycarbonates (PC), Polyetheretherketone (PEEK), Polyetherketone (PEK), Polyethylene terephthalate (PET), Polyimides, Polyoxymethylene plastic (POM/Acetal), Polyphenylene sulfide (PPS), Polyphenylene oxide (PPO), Polysulphone (PSU), Polytetrafluoroethylene (PTFE/Teflon), or Ultra-high-molecular-weight polyethylene (UHMWPE/UHMW). In some embodiments, the signal ears, ground ears, and base plates described herein are formed, in part, from materials that are substantially conductive and that are relatively easy to machine, cast and/or solder or braze. For example, the materials may include copper, aluminum, gold, silver, beryllium copper, or brass.

According to certain embodiments, the base plates described herein are designed to be modular and includes features in the ends that can mate with adjoining modules. Such interfaces can provide both structural rigidity and cross-interface conductivity. Modules may be various sizes incorporating various numbers of unit cells of radiating elements. According to certain embodiments, a module is a single unit cell. According to certain embodiments, modules are several unit cells (e.g., 2×2, 4×4), dozens of unit cells (e.g., 5×5, 6×8), hundreds of unit cells (e.g., 10×10, 20×20), thousands of unit cells (e.g., 50×50, 100×100), tens of thousands of unit cells (e.g., 200×200, 400×400), or more. According to certain embodiments, a module is rectangular rather than square (i.e., more cells along one axis than along the other).

According to certain embodiments, the base plate of the first module may include partial cutouts along its edge to mate with partial cutouts along the edge of the next module to form a receptacle to receive the radiating elements along the edges of the two modules. According to certain embodiments, the base plate of a module extends further past the last set of radiating elements along one edge than it does along the opposite edge in order to incorporate a last set of receptacles used to receive the set of radiating elements that form the transition between one module and the next. In these embodiments, the receptacles along the perimeter of the array remain empty. According to certain embodiments, a transition strip is used to join modules, with the transition strip incorporating a receptacle for the transition radiating elements. According to certain embodiments, no radiating elements bridge the transition from one module to the next. Arrays formed of modules according to certain embodiments can include various numbers of modules, such as two, four, eight, ten, fifteen, twenty, fifty, a hundred, or more.

According to certain embodiments, the base plates described herein can provide structural support for each radiating element and provide overall structural support for the array or module. A base plate may be of various thicknesses depending on the design requirements of a particular application. For example, an array or module of thousands of radiating elements may include a base plate that is thicker than the base plate of an array or module of a few hundred elements in order to provide the required structural rigidity for the larger dimensioned array. According to certain embodiments, the base plate is less than 6 inches thick. According to certain embodiments, the base plate is less than 3 inches thick, less than 1 inch thick, less than 0.5 inches thick, less than 0.25 inches thick, or less than 0.1 inches thick. According to certain embodiments, the base plate is between 0.2 and 0.3 inches thick. According to some embodiments, the thickness of the base plate may be scaled with frequency (for example, as a function of the wavelength of the highest designed frequency, λ). For example, the thickness of the base plate may be less than 1.0λ, 0.5λ, or less than 0.25λ. According to some embodiments, the thickness of the base plate is greater than 0.1λ, greater than 0.25λ, greater than 0.5λ, or greater than 1.0λ.

According to some embodiments, the form factors of radiating elements described herein may be selected to optimize the impedance of the antenna. In addition to the shape, the thickness of a radiating element ear may also affect the impedance transformation of the radiating element. According to certain embodiments, the thickness is less than 0.5 inches or less than 0.25 inches. According to certain embodiments, the thickness is preferably less than 0.125 inches, less than 0.063, less than 0.032, less than 0.016, or less than 0.008 inches. According to certain embodiments, the thickness is between 0.035 and 0.045 inches. According to certain embodiments, the thickness is greater than 0.03 inches, greater than 0.1 inches, greater than 0.25 inches, greater than 0.5 inches, or greater than 1 inch. According to some embodiments, the thickness may be scaled with frequency (for example, the distance may be a function of the wavelength of the highest designed frequency). For example, according to some embodiments, the thickness can be less than 0.2λ, less than 0.1λ, less than 0.05λ, or less than 0.01λ. According to some embodiments, the thickness can be greater than 0.005λ, greater than 0.01λ, greater than 0.05λ, or greater than 0.1λ.

According to certain embodiments, a radiating element ear includes one lobe, two lobes, four lobes, five lobes, or more. According to certain embodiments, instead of lobes, the radiating element ear includes comb-shaped teeth, saw-tooth shaped lobes, blocky lobes, or a regular wave pattern. According to some embodiments, ears of radiating elements have other shapes, for example they may be splines, or straight lines. Straight line designs may be desirable if the antenna array is designed to operate only at a single frequency, if for example, the frequency spectrum is polluted at other frequencies. As appreciated by one of ordinary skill in the art, various techniques can be used to simulate the impedance transformation of radiating elements in order to tailor the shapes of the inner-facing irregular surfaces to the impedance transformation requirements for a given phased array antenna design.

In addition to impedance matching, the shape of the inner-facing surfaces of the comb portions of the radiating element ears described herein can affect the operational frequency range of the antenna. Other design considerations may also affect the frequency range. For example, the shape of the capacitive coupling portions described herein and the manner in which they interface with adjoining capacitive coupling portions can affect the frequency range. According to certain embodiments, a radiating element can be designed with certain dimensions to operate in a radio frequency band from 1.8 to 18 GHz. For example, a radiating element may be between 0.5 inches and 0.3 inches tall (preferably between 0.45 inches and 0.35 inches tall) from the top of base plate to the top of the radiating element. According to some embodiments, the height of the radiating elements may be scaled with frequency (for example, the height may be a function of the wavelength of the highest designed frequency). For example, according to some embodiments, the height can be less than 2.0λ, less than 1.0λ, less than 0.75λ, less than 0.5λ, or less than 0.25λ. According to some embodiments, the height can be greater than 0.1λ, greater than 0.2λ, greater than 0.5λ, or greater than 1.0λ.

The posts of the radiating elements described herein may be between than 0.5 inches and 0.1 inches tall and preferably between 0.2 inches and 0.25 inches tall. The posts may be scaled by the radiating element's height. For example, the height of the posts may be equal to or less than ¾ of the element height, equal to or less than ⅔ the element height, equal to or less than ½ the element height, or equal to or less than ¼ of the element height. According to some embodiments, comb portions and/or capacitive coupling portions constitute the remainder of the element height. According to some embodiments, comb portions and/or capacitive coupling portions may be between 0.1 and 0.3 inches tall and preferably between 0.15 and 0.2 inches tall. According to certain embodiments, the distance from the outer edge of the capacitive coupling portion of a first ear to the outer edge of the capacitive coupling portion of a second ear may be between 0.15 inches and 0.30 inches and preferably between 0.2 and 0.25 inches. According to certain embodiments, these values are scaled up or down for a desired frequency bandwidth. For example, arrays designed for lower frequencies are scaled up (larger dimensions) and arrays designed for higher frequencies are scaled down (smaller dimensions).

According to certain embodiments, a radiating element may be positioned proximate to other radiating elements of the array. For example, a LHCP radiating element and a RHC radiating element may be proximately positioned and perpendicularly oriented with respect to one another. The orientation and components of the LHCP radiating element may mirror those of the RHCP radiating element, only transformed by rotation. For example, the LHCP radiating element may be rotated 90 degrees from the orientation of the RHCP radiating element such that, if the LHCP radiating element is vertically oriented, the RHCP radiating element is horizontally oriented. In some embodiments, a radiating element may be positioned proximate to two, three, four, five, or more other radiating elements of the array. One or more adjacent radiating elements may be capacitively coupled to each other.

To perform this capacitive coupling, the capacitive coupling portions of the signal ears of adjacent radiating elements may be positioned proximate to each other. For example, a signal ear of a first radiating element and a signal ear of a second radiating element may be positioned proximate to each other. According to certain embodiments, the capacitive coupling portions of each signal ear can include a triangular-shaped end piece that is shaped to present an optimal amount of surface area to each other, such that the signal ears are capacitively coupled. The triangular-shaped end pieces may be spaced apart by a certain distance or spacing. According to certain embodiments, the distance between the triangular-shaped end pieces is less than 0.5 inches, less than 0.1 inches, or less than 0.05 inches. According to certain embodiments, the spacing is less than 0.025 inches, less than 0.02 inches, less than 0.015 inches, or less than 0.010 inches. According to some embodiments, the spacing between the triangular-shaped end pieces is selected to optimize the capacitive coupling of the signal ears.

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims. Finally, the entire disclosure of the patents and publications referred to in this application are hereby incorporated herein by reference.

1. A feed combiner assembly for a phased array antenna that comprises columns of radiating element feed pins, the feed combiner assembly comprising a plurality of combiner cards, each combiner card comprising:
a connector block that comprises a plurality of connectors configured to connect to at least a portion of the radiating element feed pins of at least two of the columns of radiating element feed pins;
a first set of traces for electrically connecting radiating element feed pins of at least a portion of a first column of the at least two of the columns of radiating element feed pins;
a second set of traces for electrically connecting radiating element feed pins of at least a portion of a second column of the at least two of columns of radiating element feed pins;
a first signal line connector for connecting a first signal line to the combiner card; and
a second signal line connector for connecting a second signal line to the combiner card.

2. The feed combiner assembly of claim 1, wherein the first set of traces connects a first half of the plurality of connectors, and the second set of traces connects a second half of the plurality of connectors.

3. The feed combiner assembly of claim 2, wherein one or both of the first set of traces and the second set of traces are arranged in a branching configuration, such that each set of traces comprises a first bifurcation region in which a first parent trace branches into a pair of child traces.

4. The feed combiner assembly of claim 3, wherein each of the child traces is itself a parent trace that bifurcates to another pair of child traces.

5. The feed combiner assembly of claim 1, wherein one or both of the first set of traces and the second set of traces comprise a printed circuit board.

6. The feed combiner assembly of claim 1, wherein the plurality of connectors are arranged in rows, each row configured to connect to a separate column of radiating element feed pins.

7. The feed combiner assembly of claim 1, wherein signals are transmitted independently via the first and second signal line connectors to the phased array antenna to which the feed combiner assembly is connected.

8. The feed combiner assembly of claim 1, wherein each combiner card further comprises a cover plate configured to cover one or both of the first set of traces and the second set of traces.

9. The feed combiner assembly of claim 1, wherein each combiner card further comprises a spacer for separating the first set of traces from the second set of traces.

10. The feed combiner assembly of claim 1, wherein each combiner card connects to radiating element feed pins of one polarization.

11. The feed combiner assembly of claim 1, wherein each combiner card connects to radiating element feed pins of two or more different polarizations.

12. The feed combiner assembly of claim 1, wherein each combiner card connects to all of the radiating element feed pins of two of the columns of radiating element feed pins.

13. The feed combiner assembly of claim 1, wherein two or more combiner cards of the plurality of combiner cards are disposed next to each other such that each combiner card connects to less than all of the radiating element feed pins of two of the columns of radiating element feed pins.

14. The feed combiner assembly of claim 1, wherein each combiner card comprises:
a first beamforming integrated circuit configured to receive a first input signal from the first signal line and provide a first set of output signals to the first set of traces; and
a second beamforming integrated circuit configured to receive a second input signal from the second signal line and provide a second set of output signals to the second set of traces.

15. The feed combiner assembly of claim 14, wherein the first beamforming integrated circuit is configured to provide a first output signal having a first amplitude and phase to a first trace of the first set of traces and a second output signal having a second amplitude and phase different from the first amplitude and phase to a second trace of the first set of traces.

16. A phased array antenna comprising:
a plurality of radiating element feed pins arranged in columns; and
a feed combiner assembly comprising a plurality of combiner cards, each combiner card comprising:
a connector block that comprises a plurality of connectors configured to connect to at least a portion of the radiating element feed pins of at least two of the columns of radiating element feed pins;
a first set of traces for electrically connecting radiating element feed pins of at least a portion of a first column of the at least two of the columns of radiating element feed pins;
a second set of traces for electrically connecting radiating element feed pins of at least a portion of a second column of the at least two of columns of radiating element feed pins;
a first signal line connector for connecting a first signal line to the combiner card; and
a second signal line connector for connecting a second signal line to the combiner card.

17. A phased array antenna comprising:
a first radiating element comprising a capacitive coupling portion; and
a second radiating element comprising a capacitive coupling portion for capacitively coupling to the capacitive coupling portion of the first radiating element,
wherein at least one of the first radiating element and the second radiating element comprises a spacer disposed on the capacitive coupling portion and configured to maintain a minimum separation between the capacitive coupling portion of the first radiating element and the capacitive coupling portion of the second radiating element.

18. The phased array antenna of claim 17, wherein the spacer is disposed on a top corner of the capacitive coupling portion of the first radiating element.

19. The phased array antenna of claim 17, wherein the spacer extends a full height of the capacitive coupling portion of the first radiating element.

20. The phased array antenna of claim 17, wherein the spacer extends less than a full height of the capacitive coupling portion of the first radiating element.

21. The phased array antenna of claim 17, wherein the minimum separation is less than or equal to 0.01 inches.

22. The phased array antenna of claim 17, wherein the capacitive coupling portion of the first radiating element comprises a notch for receiving the spacer.

23. The phased array antenna of claim 17, wherein the spacer is molded onto the capacitive coupling portion of the first radiating element via overmolding, insert molding, single-shot molding, double-shot molding, co-injection molding, sandwich molding, or any combination thereof.
